(19) United States
(12) Patent Application Publication
(10) Pub. No.: US 2020/0214518 A1
(43) Pub. Date: Jul. 9, 2020

(54) TROLLEY FOR ROBOTS

(71) Applicant: THE PERFECT LITTLE COMPANY LIMITED, Didcot, Oxfordshire (GB)

(72) Inventor: Michael RICHARDSON, Didcot, Oxfordshire (GB)

(21) Appl. No.: 16/624,621

(22) PCT Filed: Jun. 22, 2018
(86) PCT No.: PCT/GB2018/051748

§ 371 Date: Dec. 19, 2019

(30) Foreign Application Priority Data
Jun. 22, 2017 (GB) 1709991.2

(51) Int. Cl. A47L 9/00; H02J 7/00; A47L 9/28; B62B 3/00

(52) U.S. Cl. CPC A47L 9/0063; H02J 7/0013; A47L 2201/022; B62B 3/005; A47L 9/2873

(57) ABSTRACT

Trolley (100) for storing, transporting and charging of a plurality of robotic appliances (10). The trolley comprises a frame (110) defining an internal volume and supporting a plurality of shelves (120), a plurality of swivelling wheels (130) attached to a lower surface of the frame, and a multi-way power connector (150) that is attached to the trolley. Each of the plurality of shelves is configured to receive and retain one or more robotic appliances and is provided with guides for routing a power cable from a location on the shelf at which a robotic appliance is retained to the multi-way power connector.

### TECHNICAL FIELD

The present invention relates to a trolley suitable for the storage, transport and charging of a plurality of robotic appliances.

### BACKGROUND

Mobile autonomous or robotic appliances are becoming increasingly commonplace and have a variety of uses, including pool cleaning, lawn mowing and floor cleaning. By way of example, FIG. 1 illustrates schematically a conventional robotic or autonomous vacuum cleaner 10 comprising a cylindrical body or housing 11, a pair of fixed axis wheels 12, a swivelling wheel or caster 13, a rotating brush/brushbar/beater brush 14, and a pair of side brushes 15.

The fixed axis wheels 12 have a common axis of rotation that is fixed relative to the housing 11, with each of the fixed axis wheels 12 being disposed on either side of the flat lower surface 11a of the housing 11, adjacent to the edge of the flat lower surface 11a of the housing 11, such that their axis of rotation is aligned with a first diameter (A) of the cylindrical housing 11. The swivelling wheel 13 is also disposed on the flat lower surface 11a of the housing 11, adjacent to the edge of the flat lower surface 11a of the housing 11, at a location that is aligned with a second diameter (B) of the cylindrical/housing, the second diameter (B) being perpendicular to the first diameter (A).

The rotating brushbar 14 is disposed within the housing 11 and partially projecting from the flat lower surface 11a of the housing 11. The rotating brushbar 14 is typically located so that the axis of rotation of the rotating brushbar 14 is parallel with the axis of rotation of the fixed axis wheels 12. The side brushes 15 are disposed on the flat lower surface 11a of the housing 11 and are each typically located adjacent to the edge of the flat lower surface 11a, on opposite sides of the flat lower surface 11a of the housing 11.

Robotic appliances that are intended for use in the home have been designed to be compact, unobtrusive and intuitive to use, and are continually decreasing in price as the technology advances and economies of scale come into play. In contrast, for robotic appliances that are intended for use in public, commercial and/or industrial environments the trend has been towards large appliances, with the logic being that a larger appliance can cover large areas quicker than a small appliance. However, these large robotic appliances are expensive, are complex to operate and maintain, and difficult to store.

The present inventors have recognised that robotic appliances that are intended for use in the home could equally be used in public, commercial and/or industrial environments provided that they are used in sufficient enough numbers to complete a given task in a sufficient time. For example, where it takes a large commercial robotic appliance to complete a task in one hour, four or more household robotic appliances could be required to complete the same task in the same amount of time. Whilst multiple small robotic appliances may be required to replicate the work of a single large robotic appliance, the cost of obtaining, running and maintaining multiple small robotic appliances is typically still significantly less than that for a single large robotic appliance. Furthermore, in view of the costs of obtaining and difficulties in storing large robotic appliances, replacements for large robotic appliances that malfunction are not often readily available. In contrast, if multiple small robotic appliances are used, tasks can still be completed even if one or two fail, and it can be cost effective to have substitute small robotic appliances readily available as backups. The only disadvantage of using multiple small robotic appliances in place of a single large robotic appliance is that each one needs to be stored, charged, and handled individually, the burden of which can exceed that of using a single large robotic appliance. The present inventors have also realised that when placing robotic devices within a storage trolley the proximity sensors thereon may detect the proximity of portions of the trolley or other robotic devices and assume the robotic device is on a floor. This can cause the robotic devices to re-energise or go into an operational mode which causes the wheels to be turned and this either wastes energy or causes the robotic devices to drive themselves off the storage shelf which can result in severe damage to the robotic device itself.

### SUMMARY

It is against this background that the invention has been made. Therefore, according to a first aspect there is provided A trolley for storing, transporting and charging of a plurality of robotic appliances having a top surface, a total height H and a lower surface, said lower surface having one or more wheels and one or more position sensors on said lower surface, the trolley comprising a frame having an outer edge and defining an internal volume and supporting a plurality of shelves positioned one on top of the other and spaced by an amount G₂. Each of the plurality of shelves may be configured to receive and retain one or more robotic appliances in a preferred position thereon. Each shelf may include one or more regions of optical transparency at positions aligned with said one or more proximity sensors on said robotic appliance when placed therein.

In one arrangement the one or more regions of optical transparency comprise apertures within said shelf. In an alternative arrangement said one or more regions of optical transparency comprise regions of optically transparent material. Said or more of said one or more shelves may comprise optically transparent material.

Preferably, the shelves are arranged to retain one or more robotic appliances at least partially within the internal volume defined by the frame.

Each shelf may comprise a sheet of material mounted to the frame, the sheet of material being provided with hollows that are configured to receive and retain one or more wheels that project from a lower surface of a robotic appliance. The sheet of material may be provided with hollows that are configured to receive and retain other features that project from the lower surface of a robotic appliance. Each shelf may comprise a plurality of sets of hollows, with each set comprising hollows that are configured to receive and retain one or more wheels that project from a lower surface of a robotic appliance. When provided, said hollows may be positioned to receive the wheels of a robotic appliance in only one pre-defined orientation thereof when placed within said trolley.

In one arrangement the one or more shelves are each arranged to retain two or more robotic appliances within the internal volume defined by the frame and each shelf comprises two separate sets of hollows, with a first set being provided on a first half of the sheet and a second set being provided on an opposite half of the sheet. Advantageously, each of the hollows is provided by any of: a hole formed in the material; and a recess or indent provided in the material or combinations thereof.

Advantageously, the multi-way power connector may be attached to the trolley within the internal volume defined by the frame. One or more of the plurality of shelves may be provided with an aperture within which the multi-way power connector can be located.

Advantageously, the frame may comprise a plurality of elongate frame sections that are connected together by connectors to form a structure in which a plurality of rectangular sub-frames are mounted one above the other.

Each shelf may comprise a sheet of material that is mounted onto the upper surface one of the rectangular sub-frames formed by the horizontal frame sections.

The guides for routing a power cable may comprise a plurality of cable retaining guides provided on the surface of a shelf.

The cable retaining guides may each comprise any of a clip and a clamp that are configured to receive and retain a cable or cable conduit.

The guides for routing a power cable may comprise a hole or aperture through a shelf.

The trolley may include a multi-way power connector and the multi-way power connector may comprise multiple sockets that are each configured to receive an electrical plug and a single power cable configured to connect the multi-way power connector to a power supply.

The trolley may include a multi-way power connector and wherein the multi-way power connector comprises an elongate power connector body that is provided with multiple sockets.

The power connector body may be provided with a first set of sockets on a first side of the power connector body and a second set of sockets on a second, opposite side of the power connector body. The multi-way power connector may be provided with ten sockets. The multi-way power connector may be attached to the trolley such that the longitudinal axis of the multi-way power connector is vertical.

In a particular arrangement the trolley comprises five shelves that can each receive and retain two separate robotic appliances.

The trolley may further comprise a drawer or storage compartment that is inserted into the frame and supported by one of the one or more further shelves.

Preferably, distance G2 is greater than the operable distance of the optical sensor on a robotic device to be placed thereon.

Advantageously, said shelves are spaced apart from each other by an amount G2 which is greater than the total height H1 of the robotic device such as to preserve a gap G3 between the bottom of any wheels and the top of any robotic device placed on a shelf therebelow.

The hollows may be positioned to receive wheels of a robotic device whilst also causing a portion of the robotic device to overhang the outer edge of the trolley.

According to another aspect of the present invention there is provided a system of robotic appliances comprising a trolley as claimed in any of the claims and a plurality of robotic appliances disposed and retained on the shelves of the trolley, each robotic appliance being connected to a power cable that is routed to the multi-way power connector that is attached to the trolley.

### BRIEF DESCRIPTION OF THE DRAWINGS

The present invention will now be more particularly described by way of example only with reference to the accompanying drawings, in which:

FIGS. 1a and 1b illustrates schematically a conventional robotic vacuum cleaner;

FIGS. 2a and 2b illustrate perspective views of an embodiment of trolley suitable for the storage, transport and charging of a plurality of robotic appliances;

FIGS. 3a and 3b illustrate side and views respectively of the trolley illustrated in FIGS. 2a and 2b;

FIGS. 4a and 4b illustrate top and bottom views respectively of the trolley illustrated in FIGS. 2a and 2b;

FIG. 5 illustrates an exploded view of the trolley illustrated in FIGS. 2a and 2b;

FIGS. 6a, 6b and 6c illustrate shelves of the trolley illustrated in FIGS. 2a and 2b;

FIG. 7 illustrates a shelf of the trolley illustrated in FIGS. 2a and 2b;

FIG. 8 illustrates a multi-way power connector suitable for use with the trolley illustrated in FIGS. 2a and 2b;

FIG. 9 is a side elevation of a robotic cleaning device; and

FIG. 10 is a side elevation of a number of robotic cleaning devices stacked on a number of shelves of the present invention.

### DETAILED DESCRIPTION

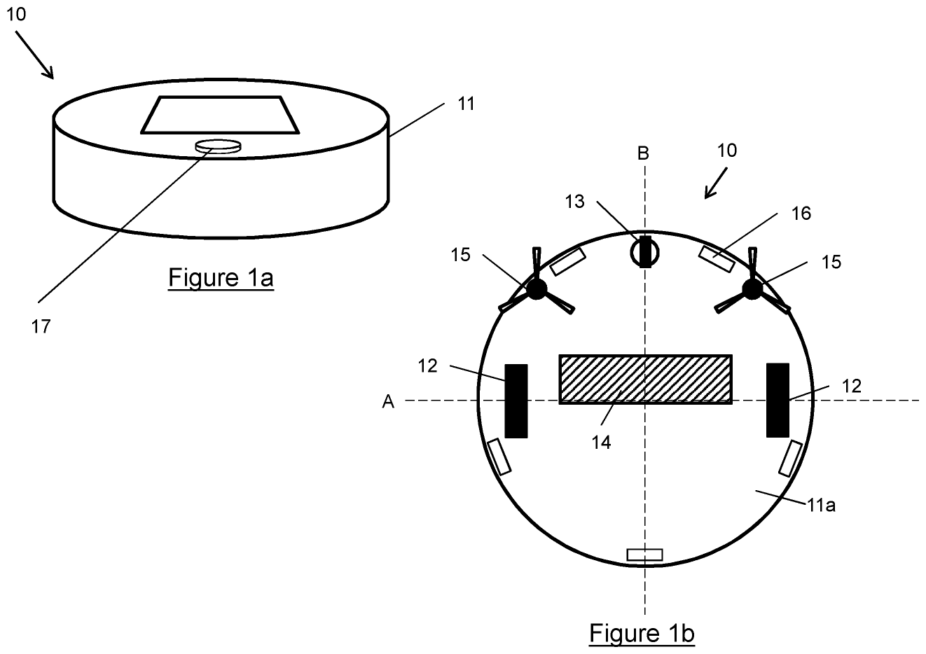

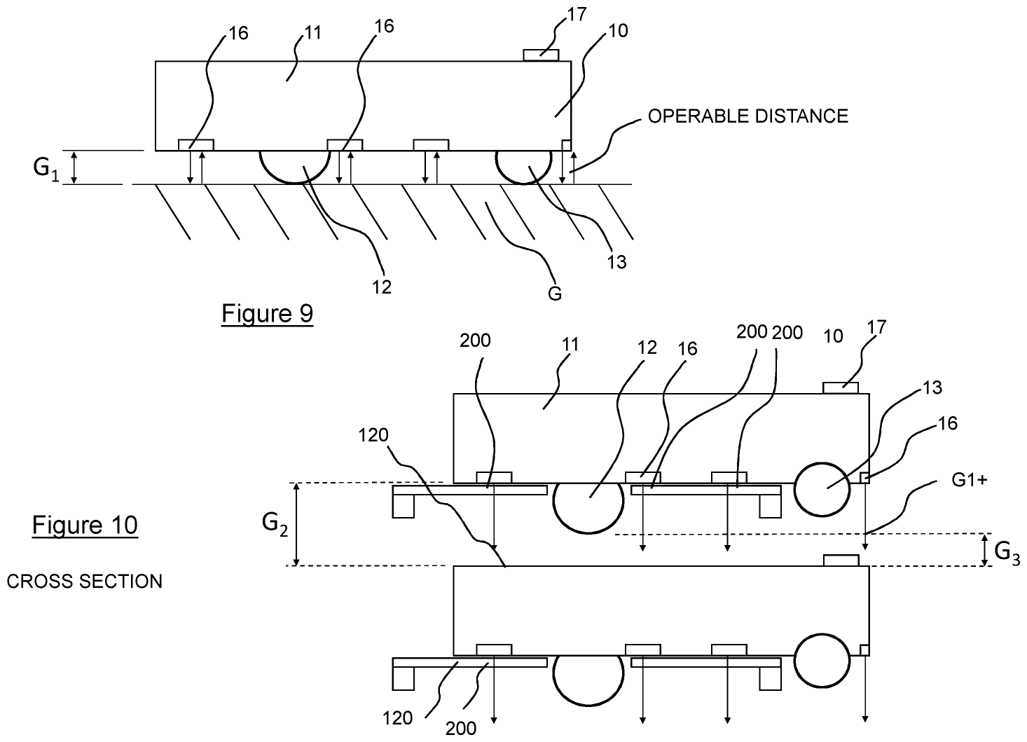

From FIGS. 1a and 1b, it will be appreciated that a robotic device 10 such as a floor vacuum usually includes a lower surface 11a and a top surface 11b, one or more wheels 12, 13 projecting from the lower surface 11b and a plurality of proximity sensors 16 on the lower surface 11a for detecting the proximity of objects there-below and which may comprise optical sensors. The device has a height H, as shown in FIG. 9 and may also include one or more further proximity sensors 17 for detecting the proximity of objects which are in front of the device 10.

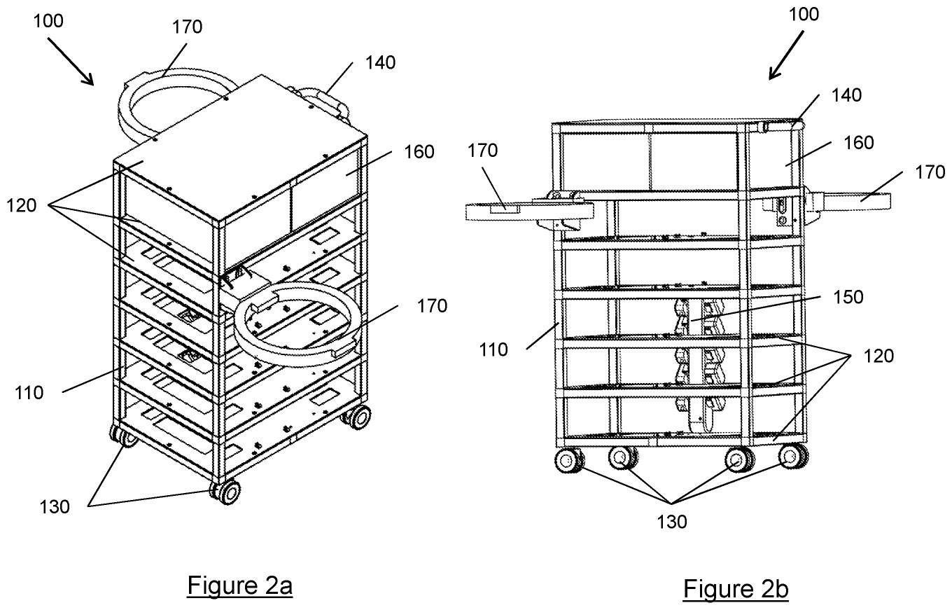

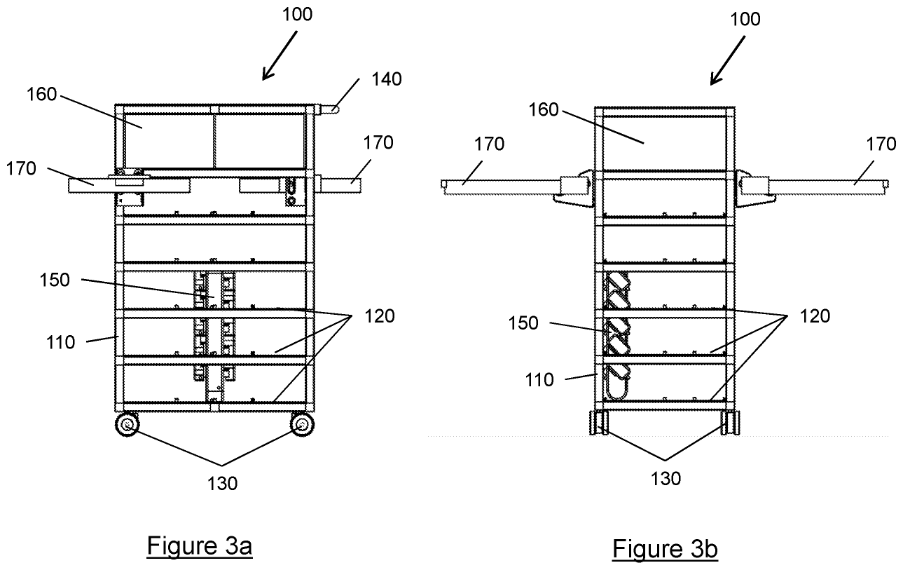

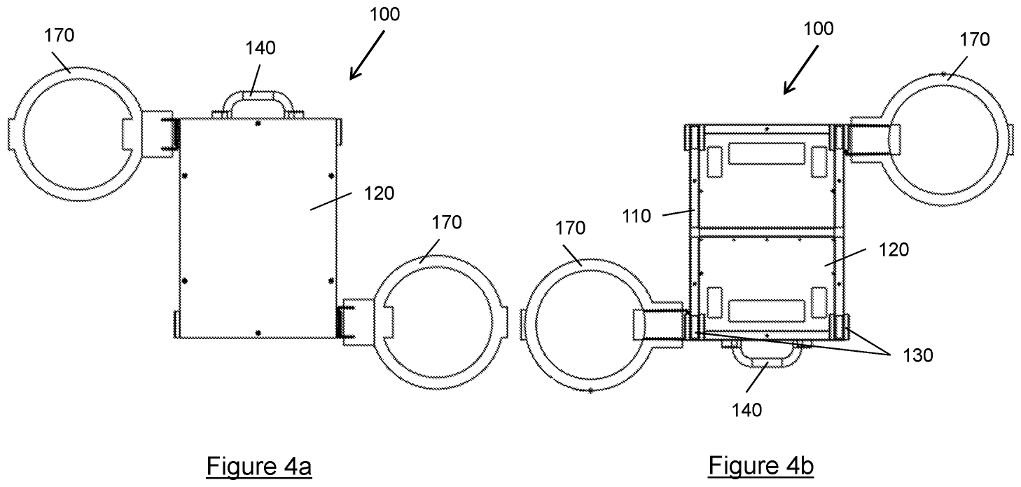

FIGS. 2a and 2b illustrate perspective views of an embodiment of trolley suitable for the storage, transport and charging of a plurality of robotic appliances. FIGS. 3a and 3b then illustrate side and views respectively of the trolley 100, whilst FIGS. 4a and 4b illustrate top and bottom views respectively of the trolley 100. The trolley 100 comprises a frame 110, a plurality of shelves 120, four swivelling wheels/castors 130, a handle 140, a multi-way power connector 150, a drawer 160 and two circular bin frames/holders 170.

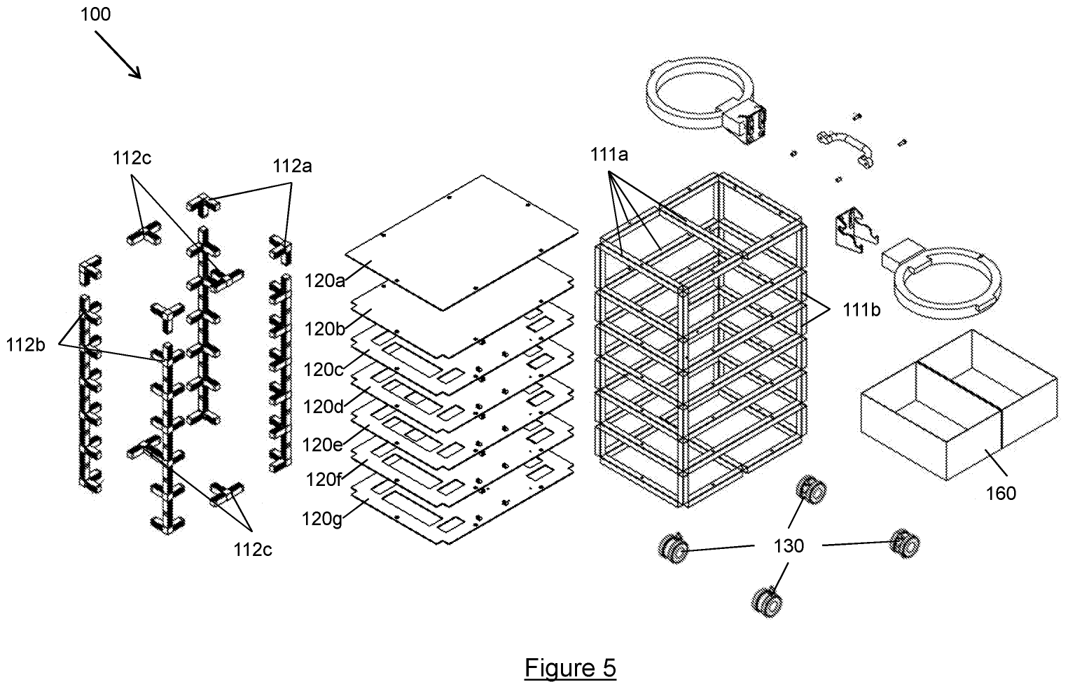

As shown in the exploded view of FIG. 5, the frame 100 comprises a plurality of elongate frame sections/bars 111 that are connected together by connectors 112 to form a structure in which a plurality of rectangular sub-frames are mounted/stacked one above the other. The frame 100 therefore has a generally box-shaped/rectangular cuboid structure. Specifically, in this embodiment the frame 100 comprises a plurality of horizontal frame sections/bars 111a that connect to form seven rectangular sub-frames, and vertical frame sections/bars 111b that are each connected between a corner of a rectangular sub-frame and a corresponding corner of another rectangular sub-frame that is disposed either directly above or directly below the rectangular sub-frame. The vertical frame sections 111b therefore connect the rectangular sub-frames formed by the horizontal frame sections 111a at each of their four corners so that they are separated vertically.

In this embodiment, there are three different types of connector 112 used to construct the frame 100; eight three-way corner connectors 112a, twenty-four-way tee/elbow corner connectors 112b, and four three-way tee connectors 112c.

The eight three-way corner connectors 112a form the corners of the frame 100. Each of these three-way corner connectors 112a connect together two of the horizontal frame sections 111a and one of the vertical frame sections 111b such that each section is perpendicular to the other sections. These three-way corner connectors 112a therefore form the corners the lowermost and uppermost rectangular sub-frames.

The twenty-four-way tee/elbow corner connectors 112b each connect together two of the horizontal frame sections 111a and two of the vertical frame sections 111b such that the two horizontal frame sections 111a are perpendicular to one another, whilst the two the vertical frame sections 111b are parallel to one another and perpendicular to both the horizontal frame sections 111a. These four-way tee/elbow corner connectors 112b therefore form the corners of the interior/intermediate rectangular sub-frames.

Of the four three-way tee connectors 112c, two are used in each of the lowermost and uppermost rectangular sub-frames and provide a means for connecting a horizontal frame section 111a across the middle of each of the lowermost and uppermost rectangular sub-frames thereby acting as a strut to improve the rigidity of the frame 110.

A swivelling wheel/castor 130 is mounted to the lower surface of the frame at each of the four corners of the lowest of the rectangular sub-frames formed by the horizontal frame sections 111a. The handle 140 is attached to an external side of one of the horizontal frame sections 111a that form the uppermost rectangular sub-frame. Attaching the swivelling wheels/castors 130 to the bottom of the frame 110 allows the trolley to be easily moved in any direction, whilst the handle 140 provides a convenient means by which a user of the trolley 100 can grip the trolley 100 in order to push and/or pull the trolley 100 around on the wheels 130.

Each of the shelves 120 comprise a sheet of material that is mounted onto the upper surface of each of the rectangular sub-frames formed by the horizontal frame sections 111a to thereby form a plurality of shelves which are vertically spaced from each other by an amount G₂.

As shown in the exploded view of FIG. 5, the first and second shelves 120a, 120b (i.e. the uppermost shelves) each comprise a sheet of material that is provided with a number of attachment points 121 around the periphery of the shelf that allow the shelf to be fixed/attached to the horizontal frame sections 111a that form the rectangular sub-frame upon which the shelf is mounted. In the illustrated embodiment, the attachment points 121 are provided by screw holes that extend through the sheet of material that forms the shelf. However, these attachment points 121 could equally be provided by any other suitable means of attachment.

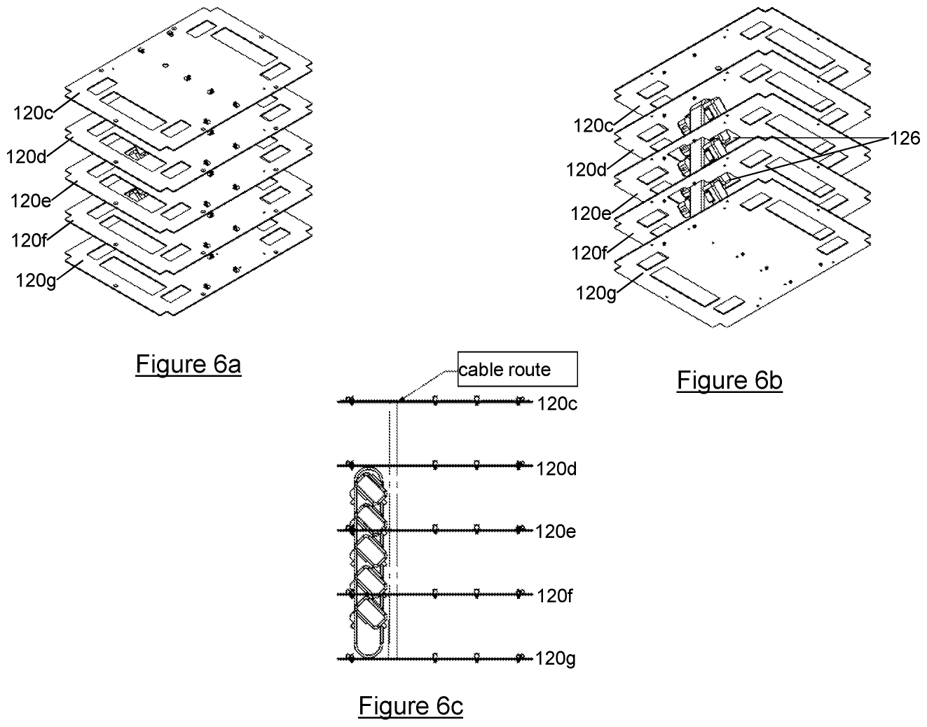

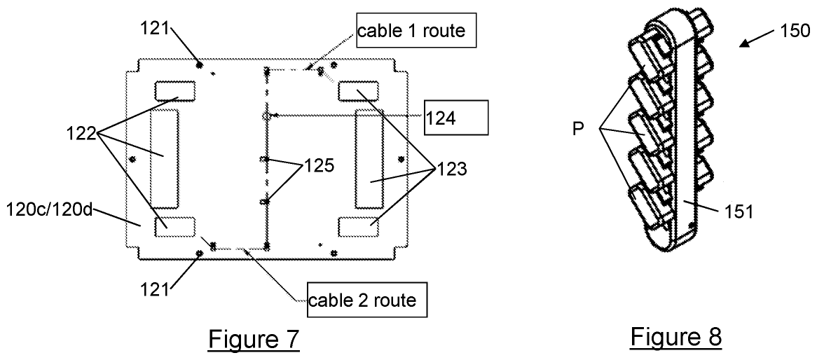

As shown in the FIGS. 6a, 6b and 7, the third and fourth shelves 120c, 120d (i.e. the shelves immediately below the second shelf 120b) each comprise a sheet of material formed with two sets of hollows 122, 123, with the first set of hollows 122 being provided on one half of the sheet and the second set of hollows 123 mirroring the first set 122 on the opposite half of the sheet. In this specific embodiment, each set of hollows 122, 123 comprises hollows that are respectively configured to receive the fixed axis wheels 12 and the rotating brush/brushbar 14 of a conventional robotic vacuum cleaner (such as that illustrated in FIG. 1). The third and fourth shelves 120c, 120d are therefore each configured to receive and retain two separate robotic vacuum cleaners, one on each half of the shelf. In the illustrated embodiment, the hollows are provided by holes that extend through the sheet of material that forms the shelf. However, these hollows could equally be provided by suitably shaped recesses/depressions formed in the material.

As with the first and second shelves 120a, 120b, the third and fourth shelves 120c, 120d are also each provided with a number of attachment points 123 around the periphery of the first shelf that allow the shelf to be fixed/attached to the horizontal frame sections 111a that form the rectangular sub-frame upon which the shelf is mounted.

The third and fourth shelves 120c, 120d are also each provided with a cable routing hole 124 through which the power cables that connect to each of the robotic vacuum cleaners can be routed. This cable routing hole 124 is located on the lateral axis of the shelf so as to be equidistant between two robotic vacuum cleaners that may be stored on the shelf.

A number of cable guides 125 are also provided on the surface of both the third and fourth shelves 120c, 120d. These cable guides 125 are configured to receive and retain the power cables that connect to each of the robotic vacuum cleaners that may be stored on the shelf, thereby routing the cables across the surface of the shelf towards the cable routing hole 124. As illustrated by the dashed lines shown in FIG. 7b, the cable guides 125 are arranged to route a cable that originates from one side of a robotic vacuum cleaner that is stored on the shelf, along the adjacent periphery of the shelf to the lateral axis of shelf, at which point the cable guides 125 are arranged to route the cable along the lateral axis to the cable routing hole 124. In the illustrated embodiment, the cable guides 125 are provided by p-clips that are attached to the shelf. However, these cable guides 125 could equally be provided by any other suitable means.

The fifth and sixth shelves 120e, 120f (i.e. the two shelves immediately below the fourth shelf 120d) are essentially/substantially the same as the fifth and sixth shelves 120e, 120f, with the only difference being that the fifth and sixth shelves 120e, 120f do not have the cable routing hole 124 but instead each have an aperture 126 within which the multi-way power connector 150 can be located. For both fifth and sixth shelves 120e, 120f, the aperture 126 is provided in a corresponding position adjacent to one longitudinal edge of the shelf and substantially aligned with the lateral axis of the shelf. When attached to the frame 100 the apertures 126 provided in both the fifth and sixth shelves 120e, 120f are aligned. The position of the apertures 126 ensures that the multi-way power connector 150 can extend through the apertures 126 without obstructing the robotic vacuum cleaners that may be stored on either fifth and sixth shelves 120e, 120f.

The seventh shelf 120g (i.e. the lowermost shelf) is essentially/substantially the same as both the third and fourth shelves 120c, 120d, with the only difference being that seventh shelf 120g does not require a cable routing hole 124.

Consequently, in the illustrated embodiment, the trolley 100 has five shelves (i.e. the third shelf 120c, fourth shelf 120d, fifth shelf 120e, sixth shelf 120f and seventh shelf 120g) that can each receive and retain two separate robotic vacuum cleaners. The trolley 100 can therefore receive and retain a total of ten robotic vacuum cleaners.

The multi-way power connector 150 essentially comprises a conventional multiple socket power connector that is configured to be connected to a separate, external power supply using a single power cable, and can therefore be used with any conventional robotic appliance that can be stored on the trolley 100. This arrangement provides that the trolley 100 can be used to store multiple robotic appliances that can all be charged simultaneously merely by connecting the multi-way power connector 150 to an external power supply using the connectors' own power cable.

As shown in FIG. 8, in the illustrated embodiment, the multi-way power connector 150 comprises an elongate power connector body 151 that is provided with five sockets on a first side of the power connector body 151 and five further sockets on a second, opposite side of the power connector body, such that the multi-way power connector 150 can be connected to up to ten robotic vacuum cleaners simultaneously. It is noted that in the figures the multi-way power connector 150 is shown with plugs (P) located within each of the ten sockets.

As shown in FIG. 6c, the multi-way power connector 150 is attached to the trolley 100 within the internal volume defined by the frame 100. In the illustrated embodiment, the multi-way power connector 150 is attached to the fifth and sixth shelves 120e, 120f so that the multi-way power connector 150 extends from the space between the sixth and seventh shelves 120f, 120g, through the apertures 126 provided in both the fifth and sixth shelves 120e, 120f, and into the space between the fifth and fourth shelves 120e, 120d. The longitudinal axis of the multi-way power connector 150 is therefore vertical when attached to the trolley 100.

Consequently, for two robotic vacuum cleaners that may be located on the seventh shelf 120g the power cables are routed along the surface of the shelf directly to the multi-way power connector 150. For two robotic vacuum cleaners that may be located on the sixth shelf 120f the power cables are also routed along the surface of the shelf directly to the multi-way power connector 150. For two robotic vacuum cleaners that may be located on the fifth shelf 120e the power cables are routed along the surface of the shelf and through the apertures 126 to the multi-way power connector 150. For two robotic vacuum cleaners that may be located on the fourth shelf 120d the power cables are routed along the surface of the shelf and through the cable routing hole 124 to the multi-way power connector 150. For two robotic vacuum cleaners that may be located on the third shelf 120c the power cables are also routed along the surface of the shelf and through the cable routing hole 124 to the multi-way power connector 150.

Preferably the trolley 100 further comprises cable trunking/cable conduits (not shown) that extends from the cable routing hole 124 provided in the third shelf 120c, through the trunking hole 124 provided in the fourth shelf 120d and through the apertures 126 provided in the fifth and sixth shelves 120e, 120f. The power cables associated with robotic vacuum cleaners that are to be stored on the trolley 100 can then be routed through the cable guides 125 on the corresponding shelf into the cable trunking and then out of the cable trunking to the appropriate socket located within the multi-way power connector 150.

The drawer 160 is inserted between first and second shelves 120a, 120b and provides storage for other items. For example, the drawer 160 could be used to store other cleaning materials and/or to store accessories/spares for use with the robotic vacuum cleaners.

In the illustrated embodiments, two circular bin frames/holders 170 are also attached to opposite sides of the trolley 100. Specifically, each of the two circular bin frames/holders 170 are attached to the outside of the frame 110 just below the second shelf 120b and the drawer 160. Each of the circular bin frames/holders 170 can be used to hold a bin bag/refuse sack. It should be noted that whilst the illustrated embodiment comprises two circular bin frames/holders 170 these are entirely optional. In addition, the trolley 100 could be used with just a single bin frames/holders, or could be used with two bin frames/holders that are located on the same side of the trolley 100.

The multi-way power connector is located within the internal volume defined by the frame of the trolley to ensure that it does not obstruct the movement of the trolley by the user. In addition, this also allows for all of the power cables to also be routed within the internal volume defined by the frame of the trolley to ensure that these do not become hazards or obstacles to the movement of the trolley or the general operation by the user, as well as ensuring the multi-way power connector is located as close as possible to the robotic appliances stored on the trolley. Furthermore, the vertical orientation of the multi-way power connector within the trolley, passing through apertures provided in the shelves, simplifies the routing of the power cables associated with each of the robotic appliances stored on the trolley whilst also providing easy access for the user to the multi-way power connector and each of its sockets. This is particularly useful should the user wish to remove and/or replace any one of the power cables for any reason.

In a preferred embodiment, the multi-way power connector provides connections/sockets for up to ten robotic appliances. Limiting the number of connections/sockets to no more than ten provides that all of the appliances connected to the multi-way power connector can be charged simultaneously without the need for complex power management systems, as the total current rating and wattage of ten conventional appliances should not exceed the maximum load for conventional power supply sockets. Consequently, in this preferred embodiment it is also preferable that the trolley is configured to provide storage for up to ten robotic appliances. This not only ensures that all of the stored appliances can be charged simultaneously using a single multi-way power connector but also ensures that the total weight of the fully loaded trolley does not place excessive strength requirements on the construction of the trolley and does not make maneuvering the trolley difficult for the user.

Reference is now made in particular to FIGS. 9 and 10 which are side elevations of a robotic device on the ground and when stacked in the trolley. From FIG. 9 and from FIGS. 1a and 1b, it will be seen that the lower surface 11a of the robotic device 10 is provided with one or more proximity sensors 16 which may be circumferentially spaced around the outer diameter thereof. These sensors 16 may comprise optical sensors but may also comprise radar or LIDAR sensors if the costs justify this selection. The sensors are provided such as to allow for the detection of a surface below the device 10 as the detection of such a surface is important to the safe operation of the device 10. in essence, the sensors 16 are used to detect when the device 10 is about to move off the surface it is presently travelling along and, potentially, drop off an edge thereof and onto a lower surface. Such an edge may be a step or a significant change of height the magnitude of which may be sufficient to damage or immobilise the device 10 which is, clearly, undesirable. These sensors are set to have an operable range so as to be able to detect a surface within a defined distance equal to or just slightly greater than the distance G₁ between the bottom surface 11a and the ground when the device is on normal operation and running on its wheels and are used to allow continuity of the power supply to the motors which drive the wheels 12, 13 so as to ensure continuity of cleaning. However, when the device 10 moves over a drop, such as a step, the sensors 16 are unable to detect a surface within their set distance and are operable to cause the steering of the device 10 away from the detected stop. Whilst this is a perfectly acceptable way of operating the device 10 in normal operation, it presents some problems when the devices 10 are stored on a conventional shelving device as the shelf is, in effect, a surface which the sensors 16 detect and this can cause the devices 10 to assume they are still in an operational environment and activate which consumes energy and activate audible warnings or the like and may cause the devices 10 to drive themselves off the shelf. The present invention solves this problem in two ways. Firstly, the shelves 120 are each provided with one or more regions 200 of optical transparency at positions aligned with said one or more proximity sensors 16 such that the sensor effectively cannot see the shelf 120 such that the device 10 assumes that it is over a free space which will cause the power to the drive motors to be cut-off. The optical transparency may be provided by providing apertures 2002 within the shelf 120. Alternatively, the optical transparency may be provided by using an optically transparent material in said regions 200.

In addition to the above the present invention also arranges the shelves 120 in spaced apart relationship such that a gap G2 will exist between the bottom of one device 10 and the top of another device 10 when they are placed on respective shelves 120. This gap G2 is selected to be greater than the operable proximity detection distance G₁ used by the sensors 16 to maintain power to the motor of the device. In such an arrangement the sensors are each unable to detect an acceptable operational surface below the device 10 and cause the power to be terminated. In essence, the gap G₂ is selected to be greater than the total height H1 of the robotic device 10 such as to preserve a gap G₃ between the bottom of the wheels 12, 13 of a device 10 and the top surface 11b of a device 10 placed therebelow. Any gap G3 would allow for the ineffective rotation of the wheels 12, 13 in the event that they are, through some external influence on the device 10 caused to go back into operational mode. Such external influence may include the insertion of an object or hand into the gap between shelves.

The present invention also provides for the positioning of the hollows to receive the wheels 12 of the device and cause a portion of the device 10 to overhang the outer edge of the trolley. Such an arrangement would cause the sensors 16 associated with the portion of the device over the edge to, effectively, detect themselves as being in free space and this may be used to prevent the supply of electricity to the motor of the device in addition or separately to the above arrangements.

The provision of the cable guides, cable routing holes and apertures enable the power cables of any conventional robotic appliance that can be stored on the shelf can easily be inserted into these routing means by the user so that the cables are also stored in a tidy and safe manner and in a way that allows the straightforward connection of a robotic appliance to a power cables when stored on a shelf.

In addition, the simple construction of the trolley, using a frame and shelves comprising sheets of material mounted to the frame, provides that the shelves can easily be interchanged if the trolley is required to store robotic appliances of a different configuration, and that therefore require different sizes and configurations of hollows to receive and retain the wheels etc. of a robotic appliance. This combined with the use of a conventional multi-way power connector allows the trolley to be used with almost any robotic appliance, and even allows the trolley to be used with a mix of different robotic appliances. For example, a subset of the shelves could be configured to store robotic floor mops whilst a further subset of the shelves could be configured to store robotic vacuum cleaners.

It will be appreciated that individual items described above may be used on their own or in combination with other items shown in the drawings or described in the description and that items mentioned in the same passage as each other or the same drawing as each other need not be used in combination with each other. In addition, the expression “means” may be replaced by actuator or system or device as may be desirable. In addition, any reference to “comprising” or “consisting” is not intended to be limiting in any way whatsoever and the reader should interpret the description and claims accordingly.

Furthermore, although the invention has been described in terms of preferred embodiments as set forth above, it should be understood that these embodiments are illustrative only. Those skilled in the art will be able to make modifications and alternatives in view of the disclosure which are contemplated as falling within the scope of the appended claims. In particular, whilst the above described examples have been described with respect to a trolley that is suitable for the storage, transport and charging of a plurality of robotic vacuum cleaners, the trolley described herein could equally be used with other mobile robotic floorcare appliances, such as robotic floor mops etc., or any other forms of mobile robotic appliances/devices such as robotic lawn mowers etc. The only modification that would be required in order to accommodate alternative forms of mobile robotic appliances onto the trolley would be to change the sizes and/or configuration of the hollows provided in the shelves so that they are suitable to receive and retain the wheels etc. of the robotic appliance that is to be stored.

1. A trolley for storing, transporting and charging of a plurality of robotic appliances having a top surface, a total height H and a lower surface, said lower surface having one or more wheels and one or more position sensors on said lower surface, the trolley comprising:
a frame having an outer edge and defining an internal volume and supporting a plurality of shelves positioned one on top of the other and spaced by an amount G₂;
wherein each of the plurality of shelves is configured to receive and retain one or more robotic appliances in a preferred position thereon; and
wherein each shelf includes one or more regions of optical transparency at positions aligned with said one or more proximity sensors on said robotic appliance when placed therein.

2. The trolley as claimed in claim 1, wherein said one or more regions of optical transparency comprise apertures within said shelf.

3. The trolley as claimed in claim 1, wherein said one or more regions of optical transparency comprise regions of optically transparent material.

4. The trolley as claimed in claim 1, wherein one or more of said one or more shelves comprise optically transparent material.

5. The trolley of claim 1, wherein the shelves are arranged to retain one or more robotic appliances at least partially within the internal volume defined by the frame.

6. The trolley of claim 1, wherein each shelf comprises a sheet of material mounted to the frame, the sheet of material being provided with hollows that are configured to receive and retain one or more wheels that project from a lower surface of a robotic appliance.

7. The trolley of claim 6, wherein the sheet of material is provided with further hollows that are configured to receive and retain other features that project from the lower surface of a robotic appliance.

8. The trolley of claim 1, wherein each shelf comprises a plurality of sets of hollows, with each set comprising hollows that are configured to receive and retain one or more wheels that project from a lower surface of a robotic appliance.

9. The trolley of claim 8, wherein said hollows are positioned to receive the wheels of a robotic appliance in only one pre-defined orientation thereof when placed within said trolley.

10. The trolley of claim 9, and including further hollows that are configured to receive and retain other features that project from the lower surface of a robotic appliance.

11. The trolley of claim 1, wherein each shelf is arranged to retain two or more robotic appliances within the internal volume defined by the frame and each shelf comprises two separate sets of hollows, with a first set being provided on a first half of the sheet and a second set being provided on an opposite half of the sheet.

12. The trolley of claim 1, wherein each of the hollows is provided by any of:
a hole formed in the material; and
a recess or indent provided in the material.

13. The trolley of claim 1, wherein the multi-way power connector is attached to the trolley within the internal volume defined by the frame.

14. The trolley of claim 1, wherein one or more of the plurality of shelves is provided with an aperture within which the multi-way power connector can be located.

15. The trolley of claim 1, wherein the frame comprises a plurality of elongate frame sections that are connected together by connectors to form a structure in which a plurality of rectangular sub-frames are mounted one above the other.

16. The trolley of claim 11, wherein each shelf comprises a sheet of material that is mounted onto the upper surface one of the rectangular sub-frames formed by the horizontal frame sections.

17. The trolley of claim 1, wherein the guides for routing a power cable comprise a plurality of cable retaining guides provided on the surface of a shelf.

18. The trolley of claim 17, wherein the cable retaining guides each comprise any of a clip and a clamp that are configured to receive and retain a cable or cable conduit.

19. The trolley of claim 17, wherein the guides for routing a power cable comprise a hole or aperture through a shelf.

20. The trolley of claim 1, and including a multi-way power connector and wherein the multi-way power connector comprises multiple sockets that are each configured to receive an electrical plug and a single power cable configured to connect the multi-way power connector to a power supply.

21. The trolley of claim 1, and including a multi-way power connector and wherein the multi-way power connector comprises an elongate power connector body that is provided with multiple sockets.

22. The trolley of claim 20, wherein the power connector body is provided with a first set of sockets on a first side of the power connector body and a second set of sockets on a second, opposite side of the power connector body.

23. The trolley of claim 20, wherein the multi-way power connector is provided with ten sockets.

24. The trolley of claim 1, wherein the multi-way power connector is attached to the trolley such that the longitudinal axis of the multi-way power connector is vertical.

25. The trolley of claim 1, wherein the trolley comprises five shelves that can each receive and retain two separate robotic appliances.

26. The trolley of claim 1, wherein the trolley further comprises a drawer or storage compartment that is inserted into the frame and supported by one of the one or more further shelves.

27. The trolley according to claim 1, and wherein distance G2 is greater than the operable distance of the optical sensor on a robotic device to be placed thereon.

28. The trolley according to claim 1, and wherein said shelves are spaced apart from each other by an amount G2 which is greater than the total height H1 of the robotic device such as to preserve a gap G3 between the bottom of any wheels and the top of any robotic device placed on a shelf therebelow.

29. The trolley according to claim 7, and wherein said hollows are positioned to receive wheels of a robotic device whilst also causing a portion of the robotic device to overhang the outer edge of the trolley.

30. A system of robotic appliances comprising:
a trolley as claimed in claim 1; and
a plurality of robotic appliances disposed and retained on the shelves of the trolley, each robotic appliance being connected to a power cable that is routed to the multi-way power connector that is attached to the trolley.
